(19) United States
(12) Patent Application Publication
(10) Pub. No.: US 2026/0214344 A1
(43) Pub. Date: Jul. 23, 2026

(54) IMAGING DEVICE, IMAGING CONTROL METHOD, AND IMAGING CONTROL PROGRAM

(71) Applicant: TOYOTA JIDOSHA KABUSHIKI KAISHA, Aichi-ken (JP)

(72) Inventor: Satoshi NAITO, Yokohama-shi (JP)

(21) Appl. No.: 19/454,249

(22) Filed: Jan. 20, 2026

(30) Foreign Application Priority Data
Jan. 23, 2025 (JP) 2025-009993

(51) Int. Cl. H04N 23/72; H04N 23/11; H04N 23/73; H04N 23/74

(52) U.S. Cl. CPC H04N 23/72; H04N 23/11; H04N 23/73; H04N 23/74

(57) ABSTRACT

An imaging device includes: first and a second cameras each having sensitivity to invisible light; a first irradiation unit configured to irradiate an imaging range of the first camera with the invisible light; a second irradiation unit configured to irradiate an imaging range of the second camera with the invisible light; and a control unit configured to control the first and second cameras, and the first and second irradiation units. An irradiation range of the invisible light by the first irradiation unit at least partially overlaps an irradiation range of the invisible light by the second irradiation unit. The control unit stops invisible light irradiation by the first irradiation unit and the second irradiation unit when exposure to the visible light is performed in the at least one of the first camera and the second camera.

### FIELD

The present disclosure relates to an imaging device, an imaging control method, and an imaging control program.

### BACKGROUND

In the related art, there has been known an imaging system that includes a plurality of infrared camera modules that perform imaging after irradiation of infrared light and performs imaging at the same timing by the infrared camera modules (JP 6743708 B). In particular, in the imaging system described in Patent Document 1, in order to suppress deterioration of image quality caused by simultaneously performing irradiation of the infrared light from the infrared camera modules located close to each other for imaging by the infrared camera modules, imaging is performed at different timings in the infrared camera modules.

Incidentally, in the imaging system including the plurality of infrared camera modules, it is conceivable to perform imaging of an image of visible light in addition to an image of the infrared light. In this case, when in a state in which the infrared light is emitted in one camera module in order to image the image of the infrared light, another camera module images the image of the visible light, and the infrared light emitted from the one camera module may have an influence such as an increase in redness on the image of the visible light imaged by the other camera module.

In view of the above problem, an object of the present disclosure is to suppress the influence of the infrared light emitted to image the image of the infrared light on the image of the visible light.

### SUMMARY

The present disclosure includes the following aspects.
(1) An imaging device configured to perform imaging, comprising:
   a first camera and a second camera each having sensitivity to invisible light;
   a first irradiation unit configured to irradiate an imaging range of the first camera with the invisible light during an exposure period of the invisible light in the first camera;
   a second irradiation unit configured to irradiate an imaging range of the second camera with the invisible light during an exposure period of the invisible light in the second camera; and
   a control unit configured to control the first camera, the second camera, the first irradiation unit, and the second irradiation unit, wherein
   an irradiation range of the invisible light by the first irradiation unit at least partially overlaps an irradiation range of the invisible light by the second irradiation unit,
   at least one of the first camera and the second camera has sensitivity also to visible light, and
   the control unit stops invisible light irradiation by the first irradiation unit and the second irradiation unit when exposure to the visible light is performed in the at least one of the first camera and the second camera.
(2) The imaging device according to above (1), wherein
   the first camera and the second camera both have sensitivity to the visible light, and
   the control unit causes both the first camera and the second camera to simultaneously perform exposure to the visible light.
(3) The imaging device according to above (1) or (2), wherein
   in each imaging cycle, the control unit does not simultaneously perform irradiation by the first irradiation unit and exposure to the invisible light in the first camera, and irradiation by the second irradiation unit and exposure to the invisible light in the second camera.
(4) The imaging device according to above (3), wherein
   in each imaging cycle, the control unit performs the irradiation by the first irradiation unit and the exposure to the invisible light in the first camera after the exposure to the visible light in the first camera or the second camera and before the irradiation by the second irradiation unit and the exposure to the invisible light in the second camera are performed, and
   the control unit starts the irradiation by the second irradiation unit and the exposure to the invisible light in the second camera after completion of the irradiation by the first irradiation unit and the exposure to the invisible light in the first camera and before completion of the readout for the invisible light from the first camera.
(5) The imaging device according to above (4), wherein
   in each imaging cycle, the control unit starts the exposure to the visible light in the at least one of the first camera and the second camera after completion of the irradiation by the second irradiation unit and the exposure to the invisible light in the second camera and before completion of the readout from the second camera corresponding to the exposure.
(6) The imaging device according to any one of above (3) to (5), wherein
   in each imaging cycle, the control unit starts the irradiation by the first irradiation unit and the exposure to the invisible light in the first camera after the exposure to the visible light and the readout corresponding to the exposure are completed in the at least one of the first camera and the second camera.
(7) The imaging device according to any one of above (1) to (6), wherein
   the control unit performs exposure to the invisible light and readout corresponding to the exposure in the first camera and the second camera in a global shutter system, and performs the exposure to the visible light and readout corresponding to the exposure in the first camera and the second camera in a rolling shutter system.
(8) The imaging device according to any one of above (1) to (7), wherein
   the invisible light is infrared light.
(9) The imaging device according to any one of above (1) to (8), wherein
   the imaging device is equipped on one vehicle.
(10) The imaging device according to above (9), wherein
   the first camera and the second camera are disposed to image the same passenger of the vehicle.
(11) An imaging control method, the method controlling
   a first camera and a second camera each having sensitivity to visible light and invisible light,
   a first irradiation unit configured to irradiate an imaging range of the first camera with the invisible light during an exposure period of the invisible light in the first camera, and
   a second irradiation unit configured to irradiate an imaging range of the second camera with the invisible light during an exposure period of the invisible light in the second camera, wherein
   an irradiation range of the invisible light by the first irradiation unit at least partially overlaps an irradiation range of the invisible light by the second irradiation unit, and
   the imaging control method comprises stopping invisible light irradiation by the first irradiation unit and the second irradiation unit when exposure to the visible light is performed in at least one of the first camera and the second camera.
(12) An imaging control program, the program being configured to control
   a first camera and a second camera each having sensitivity to visible light and invisible light,
   a first irradiation unit configured to irradiate an imaging range of the first camera with the invisible light during an exposure period of the invisible light in the first camera, and
   a second irradiation unit configured to irradiate an imaging range of the second camera with the invisible light during an exposure period of the invisible light in the second camera, wherein
   an irradiation range of the invisible light by the first irradiation unit at least partially overlaps an irradiation range of the invisible light by the second irradiation unit, and
   the imaging control program causes a computer to execute stopping of invisible light irradiation by the first irradiation unit and the second irradiation unit when exposure to the visible light is performed in at least one of the first camera and the second camera.

### BRIEF DESCRIPTION OF DRAWINGS

FIG. 1 is a configuration diagram schematically illustrating a configuration of an imaging device according to a first embodiment.

FIG. 2 is a schematic side view partially illustrating an interior of a vehicle equipped with the imaging device.

FIG. 3 is a functional block diagram of a processor of a control device.

FIG. 4 is a time chart showing an irradiation timing and the like of infrared light by a first projector.

FIG. 5 is a time chart similar to FIG. 4, showing the irradiation timing and the like of the infrared light by the first projector when control according to a second embodiment is performed.

### DESCRIPTION OF EMBODIMENTS

Hereinafter, embodiments will be described in detail with reference to the drawings. In the following description, similar components are denoted by the same reference numerals.

### First Embodiment

### Configuration of Imaging Device

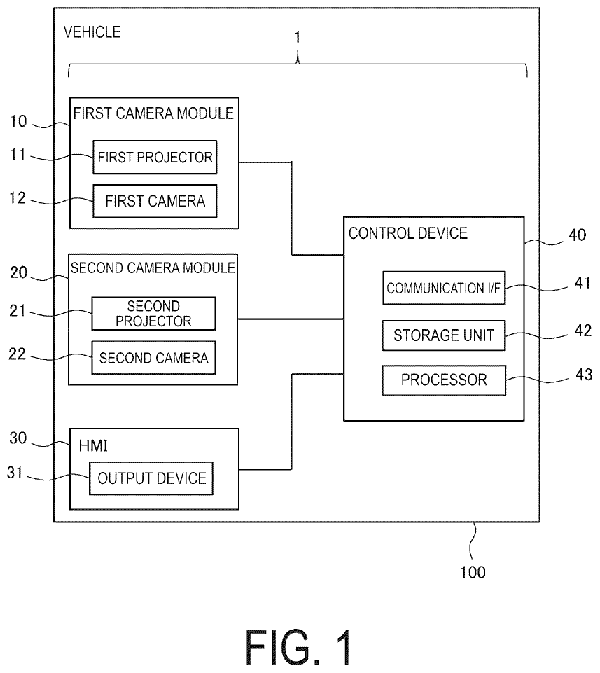

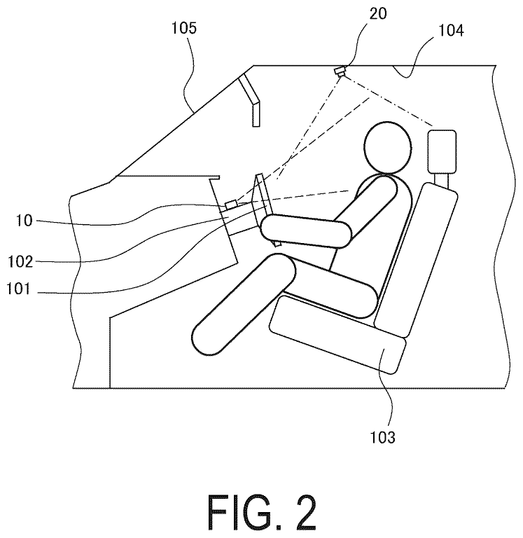

First, a configuration of an imaging device 1 according to a first embodiment will be described with reference to FIGS. 1 and 2. FIG. 1 is a configuration diagram schematically illustrating a configuration of an imaging device 1 according to a first embodiment. FIG. 2 is a schematic side view partially illustrating an interior of a vehicle 100 equipped with the imaging device 1. The imaging device 1 is equipped on one vehicle 100 and performs imaging of an object in the vehicle 100. In the present embodiment, the imaging device 1 images the object in the vehicle 100, for example, a passenger of the vehicle 100, by a plurality of cameras whose imaging ranges at least partially overlap each other.

In the present embodiment, the imaging device 1 includes a first camera module 10, a second camera module 20, a human-machine interface (HMI) 30, and a control device 40. The first camera module 10, the second camera module 20, and the HMI 30 are connected to the control device 40 via signal lines.

The first camera module 10 images a driver (particularly, a face of the driver) for the main purpose of detecting a face direction, a line-of-sight direction, an open/closed state of eyes, and the like of the driver of the vehicle 100. In the present embodiment, as illustrated in FIG. 2, the first camera module 10 is disposed on an upper portion of a steering column 102 so as to face the face of the driver. The first camera module 10 may be disposed on a steering wheel 101, a room mirror, a meter panel, a meter hood, or the like as long as the first camera module 10 can image the face of the driver.

The first camera module 10 includes a first projector 11 and a first camera 12. In the present embodiment, the first projector 11 and the first camera 12 are integrally configured as the first camera module 10, but the first projector 11 and the first camera 12 may be separately disposed as separate devices.

The first projector 11 is an example of a first irradiation unit that irradiates an imaging range of the first camera 12 with infrared light. In the present embodiment, the first projector 11 emits the infrared light of a predetermined wavelength (for example, 850 nm or 940 nm) during an exposure period in the first camera 12. The first projector 11 includes an infrared light emitting diode that emits the infrared light. The first projector 11 performs irradiation of the infrared light according to a signal from the control device 40.

The first camera 12 is a camera having sensitivity to the infrared light and visible light. The first camera 12 receives reflected light of the infrared light emitted from the first projector 11 and reflected by a subject, and performs imaging. The first camera 12 receives reflected light of the visible light emitted from any light source such as the sun, a street light, or a vehicle interior light and reflected by the subject, and performs imaging. The first camera 12 transmits the imaged infrared light image and visible light image to the control device 40.

The first camera 12 includes an image sensor (for example, a complementary metal oxide semiconductor (CMOS) image sensor or a charge coupled device (CCD) image sensor), a filter that transmits the infrared light, a filter that transmits the visible light, and an imaging optical system that forms an image of a region to be imaged on a photoelectric conversion element (for example, a photodiode) of the image sensor. The filter that transmits the visible light includes color filters that transmit light of each of RGB.

The image sensor of the first camera 12 includes a photoelectric conversion element such as a photodiode and a capacitor. In particular, the image sensor includes a plurality of the photoelectric conversion elements arranged in a two dimensional array and a plurality of the capacitors corresponding to the respective photoelectric conversion elements.

When the photoelectric conversion element receives light, the photoelectric conversion element generates charges corresponding to an intensity of the received light, and the capacitor accumulates the charges generated in the photoelectric conversion element. In the present embodiment, since the filter is disposed in front of the image sensor, the photoelectric conversion element generates the charges corresponding to the intensity of light transmitted through the corresponding filter. In the present embodiment, a color filter that transmits light of any RGB or a filter that transmits infrared light is provided for each photoelectric conversion element. Thus, each photoelectric conversion element generates the charges corresponding to the intensity of the light of any color of RGB or the infrared light. For example, a photoelectric conversion element provided with a filter that transmits red color (R) light generates the charges corresponding to an intensity of the red color (R) light. Similarly, the photoelectric conversion element provided with the filter that transmits the infrared light generates the charges corresponding to the intensity of the infrared light.

The first camera 12 can change an exposure period that is a period in which the charges accumulated in the capacitor are generated in the photoelectric conversion element by irradiating the photoelectric conversion element with the infrared light and the visible light. In particular, in the present embodiment, the first camera 12 can separately change the exposure period of the infrared light that is a period in which the charges are generated in the photoelectric conversion element by irradiating the photoelectric conversion element provided with the filter that transmits the infrared light with the infrared light, and an exposure period of the visible light that is a period in which the charges are generated in the photoelectric conversion element by irradiating the photoelectric conversion element provided with the filter that transmits the visible light with the visible light. In the present specification, the generation of the charges accumulated in the capacitor in the photoelectric conversion element by irradiating the photoelectric conversion element with light is referred to as exposure in the camera.

The capacitor accumulates the charges generated in the photoelectric conversion element during the exposure period, and the charges accumulated in the capacitor are transferred after completion of the exposure period. The intensity of light received by the photoelectric conversion element corresponding to each pixel is detected according to the amount of the charges transferred in this manner. In the present specification, such transfer of the charges from the capacitor is referred to as readout in the camera. In particular, in the present specification, transfer of the charges from the capacitor corresponding to the photoelectric conversion element provided with the filter that transmits the infrared light is referred to as readout for the infrared light in the camera, and transfer of the charges from the capacitor corresponding to the photoelectric conversion element provided with the filter that transmits the visible light is referred to as readout for the visible light in the camera. The transfer of the charge accumulated in the capacitor is performed immediately after the completion of the exposure period. Thus, the readout for the infrared light or the visible light in the first camera 12 is performed immediately after the exposure to the infrared light or the visible light in the first camera 12 is performed.

In the present embodiment, the exposure to the infrared light in the first camera 12 and the readout for the infrared light performed immediately thereafter are performed by a global shutter method. Thus, the exposure is simultaneously performed in the photoelectric conversion elements corresponding to all the pixels, and then transfer is sequentially performed from the capacitors corresponding to all the pixels. In the first camera 12, since imaging is performed by the global shutter method, exposure is simultaneously performed in all the photoelectric conversion elements (that is, all the pixels), and thus, it is possible to shorten a time in which the exposure is performed in any photoelectric conversion element (that is, any pixel) in an imaging time including the exposure and the readout.

On the other hand, in the present embodiment, the exposure to the visible light in the first camera 12 and the readout for the visible light performed immediately thereafter are performed by a rolling shutter method. Thus, exposure to the visible light in the photoelectric conversion elements is performed in order for each column, and transfer is performed from the capacitors corresponding to the photoelectric conversion elements in order for each column in which exposure has been performed.

In the present embodiment, imaging with the visible light is performed by the rolling shutter method in the first camera 12, and thus, it is possible to increase an exposure time in each photoelectric conversion element (that is, each pixel) in the imaging time including the exposure and the readout, and to increase a resolution of the imaged image. In addition, in the imaging of the visible light, the exposure and the readout are performed for three pieces of light of RGB, and thus, in a case where the imaging is performed by the global shutter method, a necessary frame buffer memory is large as compared with, for example, imaging of the monochromatic infrared light. In contrast, the necessary frame buffer memory can be reduced by performing the imaging by the rolling shutter method for the visible light.

In the first camera 12 of the present embodiment, the readout from the corresponding capacitor is performed in different systems in the photoelectric conversion element provided with the filter that transmits the infrared light and in the photoelectric conversion element provided with the filter that transmits the visible light. Thus, the first camera 12 and the second camera 22 can perform the readout for the infrared light while performing the exposure to the visible light, and can perform the readout for the visible light while performing the exposure to the infrared light.

The second camera module 20 images a seat 103 (or a region including a hand of a passenger (a driver and an occupant on a passenger seat) seated on the seat 103) from above for the main purpose of detecting a movement (for example, an operation of a navigation device, and a pointing movement) of the hand of the passenger seated on the seat 103 (including the passenger seat) of the vehicle 100. As illustrated in FIG. 2, the second camera module 20 is disposed on a ceiling 104 of the vehicle 100 so as to face the seat 103. Thus, the face of the driver is included in an imaging range of the second camera module 20, and thus an imaging range of the first camera module 10 and the imaging range of the second camera module 20 partially overlap each other. In particular, in the present embodiment, the first camera module 10 and the second camera module 20 are disposed so as to image the same passenger (driver). The second camera module 20 may be disposed on an upper portion of a front window 105 or the like as long as the second camera module 20 can image the seat 103 from above.

The second camera module 20 also includes a second projector 21 and a second camera 22, similarly to the first camera module 10. In the present embodiment, the second projector 21 and the second camera 22 are integrally configured as the second camera module 20, but the second projector 21 and the second camera 22 may be separately disposed as separate devices.

The second projector 21 is an example of a second irradiation unit that irradiates an imaging range of the second camera 22 with the infrared light. The second projector 21 has a configuration similar to that of the first projector 11. Thus, during the exposure period of the second camera 22, the second projector 21 emits the infrared light having the same or substantially the same wavelength as the infrared light emitted by the first projector 11.

The second camera 22 is a camera having sensitivity to the infrared light and the visible light. The second camera 22 receives reflected light of the infrared light emitted from the second projector 21 and reflected by a subject, and performs imaging. The second camera 22 receives reflected light of the visible light emitted from any light source such as the sun, a street light, or a vehicle interior light and reflected by the subject, and performs imaging. The second camera 22 also transmits the imaged infrared light image and visible light image to the control device 40. The second camera 22 also has a configuration similar to that of the first camera 12, and includes an image sensor, a filter that transmits infrared light, a filter that transmits visible light, and an imaging optical system. Also in the second camera 22, the readout for the infrared light or the visible light in the second camera 22 is performed immediately after the exposure to the infrared light or the visible light in the second camera 22 is performed.

In the present embodiment, the exposure to the infrared light in the second camera 22 and the readout for the infrared light performed immediately thereafter are performed by the global shutter method, similarly to the first camera 12. In addition, the exposure to the visible light in the second camera 22 and the readout for the visible light performed immediately thereafter are performed by the rolling shutter method, similarly to the first camera 12. Furthermore, in the second camera 22 of the present embodiment, the readout from the corresponding capacitor is performed in different systems in the photoelectric conversion element provided with the filter that transmits the infrared light and in the photoelectric conversion element provided with the filter that transmits the visible light.

The first camera module 10 and the second camera module 20 may be used for purposes different from the above-described purposes. For example, the second camera module 20 may be used for the main purpose of detecting a wearing/unwearing state of the seat belt of the passenger seated on each seat of the vehicle 100. Alternatively, the second camera module 20 may be used for the main purpose of detecting an operation of a smartphone by the driver of the vehicle 100.

In addition, the first camera module 10 and the second camera module 20 may be disposed at positions different from the above-described positions. For example, both the first camera module 10 and the second camera module 20 may be disposed on the ceiling 104 so as to image the sheet 103 from above at different angles. In this case, for example, one camera module is used for the main purpose of detecting the wearing/unwearing state of the seat belt of the passenger, and the other camera module is used for the main purpose of detecting the movement of the hand of the passenger.

However, in any case, the first camera module 10 and the second camera module 20 are disposed such that the imaging range of the first camera 12 and the imaging range of the second camera 22 at least partially overlap each other. Thus, in either case, the first camera module 10 and the second camera module 20 are disposed such that the irradiation range of the infrared light by the first projector 11 and the irradiation range of the infrared light by the second projector 21 at least partially overlap each other.

Further, the first projector 11 and the second projector 21 project the infrared light, but may project invisible light other than the infrared light. The first camera 12 and the second camera 22 may be cameras having sensitivity to the invisible light other than the infrared light.

In the present embodiment, the imaging device 1 includes two camera modules, namely, the first camera module 10 and the second camera module 20. However, the imaging device 1 may include three or more camera modules. In this case, for each of the plurality of camera modules, the imaging range of each camera at least partially overlaps the imaging range of another camera, and thus the irradiation range of the infrared light by each projector at least partially overlaps the irradiation range of the infrared light by another projector.

The HMI 30 is a user interface for exchanging information between the vehicle 100 and the passenger of the vehicle 100. The HMI 30 includes an output device 31 for notifying the passenger through a body sensation (for example, a sense of sight, a sense of hearing, and a sense of touch) of the passenger. The output device 31 is, for example, displays (for example, a meter display, a center display, and a head-up display), a speaker, and a vibrating body. For example, in the control device 40, when inattentiveness or drowsiness of the driver is detected based on the image imaged by the first camera 12, a warning is issued to the passenger by the output device 31.

The control device 40 controls the first camera module 10 (the first projector 11 and the first camera 12), the second camera module 20 (the second projector 21 and the second camera 22), and the HMI 30. In the present embodiment, the control device 40 controls a timing of irradiation start and irradiation time by the projectors 11 and 21 of both camera modules, that is, controls the irradiation period by the projectors 11 and 21. The control device 40 controls a timing of exposure start and the exposure time of the infrared light and the visible light by the cameras 12 and 22 of both camera modules, that is, controls the exposure period of the infrared light and the visible light in the cameras 12 and 22. In addition, the control device 40 controls notification to the passenger by the output device 31 of the HMI 30.

The control device 40 includes a communication interface 41, a storage unit 42, and a processor 43. The communication interface 41, the storage unit 42, and the processor 43 may be configured as separate circuits or may be configured as a single integrated circuit such as a system on a chip (SoC).

The communication interface 41 includes an interface circuit for connecting the control device 40 to other devices such as the first camera module 10. The control device 40 is connected to other devices via the communication interface 41. The communication interface 41 transmits data representing the imaged images received from the first camera module 10 and the second camera module 20 to the processor 43. The communication interface 41 transmits a signal output from the processor 43 to the first camera module 10, the second camera module 20, and the output device 31 of the HMI 30.

The storage unit 42 is a device that stores data, and is a non-transitory storage medium. The storage unit 42 includes, for example, a volatile semiconductor memory (for example, a dynamic random access memory (DRAM) and a static random access memory (SRAM)) and a nonvolatile semiconductor memory (for example, a read only memory (ROM), an electrically erasable programmable read only memory (EEPROM), and a flash memory). The storage unit 42 may include a hard disk drive (HDD) and a solid state drive (SSD). The storage unit 42 stores a computer program executed by the processor 43. The storage unit 42 stores data and the like representing images imaged by the first camera 12 and the second camera 22.

The processor 43 includes one or a plurality of CPUs (Central Processing Units) and a peripheral circuit thereof. The processor 43 may further include another operation circuit such as a logic operation unit, an arithmetic logic unit, or a graphics processor unit. The processor 43 executes the computer program stored in the storage unit 42.

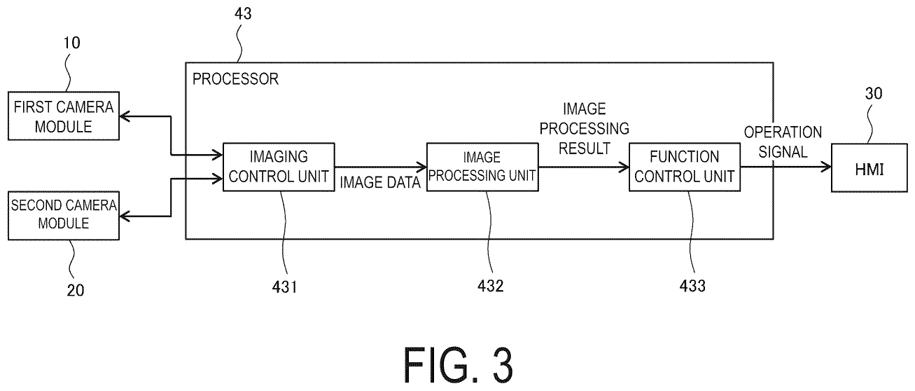

FIG. 3 is a functional block diagram of the processor 43 of the control device 40. As illustrated in FIG. 3, the processor 43 includes an imaging control unit 431, an image processing unit 432, and a function control unit 433. These units included in the processor 43 are, for example, functional modules executed by the computer program operating on the processor 43. Alternatively, these units included in the processor 43 may be mounted to the control device 40 as independent integrated circuits, microprocessors, or firmware.

The imaging control unit 431 controls the camera modules 10 and 20. The imaging control unit 431 transmits an exposure start signal to each of the camera modules 10 and 20 at a timing to start the exposure to the infrared light and the visible light in the corresponding cameras 12 and 22. The imaging control unit 431 transmits an irradiation start signal to each of the camera modules 10 and 20 at a timing to start the irradiation of the infrared light by the corresponding projectors 11 and 21.

In the present embodiment, the exposure start signal may include a signal indicating the exposure time in the corresponding cameras 12 and 22. Similarly, in the present embodiment, the irradiation start signal may include a signal indicating the irradiation time of the infrared light by the corresponding projectors 11 and 21.

When the first camera module 10 receives the exposure start signals of the infrared light and the visible light from the imaging control unit 431, the first camera module 10 starts the exposure to the infrared light and the visible light in the first camera 12. Thereafter, when a predetermined exposure time or an exposure time included in the exposure start signal elapses, the first camera module 10 ends the exposure to the infrared light or the visible light in the first camera 12 and executes the readout for the infrared light or the visible light. Further, when the first camera module 10 receives the irradiation start signal from the imaging control unit 431, the first camera module 10 starts the irradiation of the infrared light by the first projector 11, and then, when a predetermined irradiation time or an irradiation time included in the irradiation start signal elapses, the first camera module 10 ends the irradiation of the infrared light by the first projector 11. Similarly, the second camera module 20 also controls the exposure and the readout in the second camera 22 and the irradiation of the infrared light by the second projector 21.

The imaging control unit 431 receives, from the camera modules 10 and 20, data (image data) representing the infrared light image and the visible light image imaged by the cameras 12 and 22 of the camera modules 10 and 20. When the imaging control unit 431 receives the image data, the imaging control unit 431 transmits the received image data to the image processing unit 432. The image processing unit 432 may directly receive the image data from each of the camera modules 10 and 20.

The image processing unit 432 performs image processing on an image represented by the received image data. In the present embodiment, the image processing unit 432 analyzes the image including the face of the driver imaged by the first camera 12 and detects the face direction, the line-of-sight direction, a degree of eye opening of the eyes, and the like of the driver. The detection of the face direction of the driver and the like is performed by any image processing method such as using a learned machine learning model. In the present embodiment, the image processing unit 432 analyzes an image of the surroundings of each seat 103 imaged by the second camera 22, and detects the movement of the hand of the passenger seated on each seat 103. The detection of the movement of the hand of the passenger is also performed by any image processing method such as using the learned machine learning model. The image processing unit 432 transmits data representing the detected face direction of the driver and the like and data representing the movement of the hand of the passenger to the function control unit 433.

The function control unit 433 controls a function of the vehicle 100 based on the data representing the result of the image processing received from the image processing unit 432.

In the present embodiment, the function control unit 433 detects inattentiveness or drowsiness of the driver based on the face direction, the line-of-sight direction, and the degree of eye opening of the eyes of the driver transmitted from the image processing unit 432, and controls the HMI 30 according to the detection result. For example, when the inattentiveness or drowsiness of the driver is detected, the function control unit 433 transmits a signal instructing the output device 31 of the HMI 30 to execute a warning to the passenger.

In the present embodiment, the function control unit 433 detects whether the operation of the navigation device or the pointing movement by the passenger is performed based on the data representing the movement of the hand of the passenger transmitted from the image processing unit 432, and controls the HMI 30 according to the detection result. For example, when the pointing movement by the passenger is detected, the function control unit 433 searches for a shop or the like present in a pointing direction of the passenger, and transmits a signal for instructing the output device 31 of the HMI 30 to execute notification of information of the searched shop or the like to the passenger.

### Control in Control Device

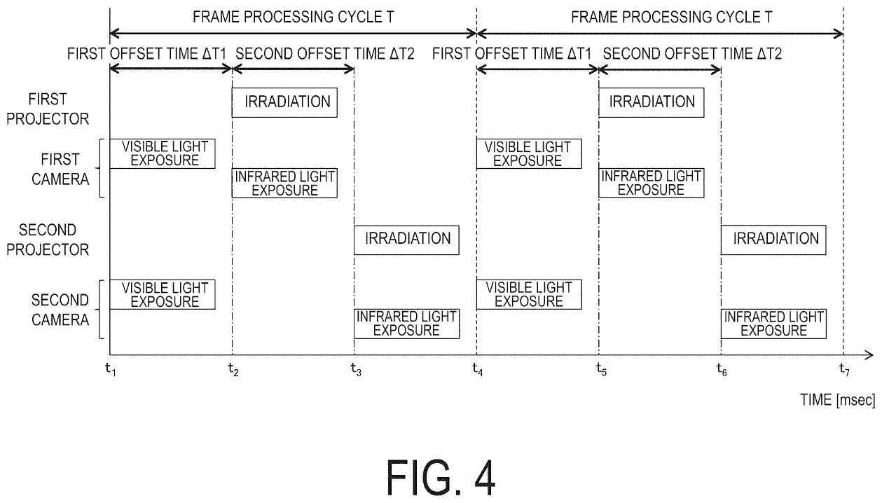

Next, control of the first camera module 10 and the second camera module 20 by the control device 40 will be described with reference to FIG. 4. In particular, in the following, control of the first projector 11, the first camera 12, the second projector 21, and the second camera 22 by the imaging control unit 431 will be described.

When the exposure to the infrared light in the first camera 12 and the exposure to the infrared light in the second camera 22 are simultaneously performed, the irradiation of the infrared light by the first projector 11 and the irradiation of the infrared light by the second projector 21 are simultaneously performed. On the other hand, as described above, the imaging range of the first camera 12 and the imaging range of the second camera 22 partially overlap each other, and thus the irradiation range of the infrared light by the first projector 11 and the irradiation range of the infrared light by the second projector 21 partially overlap each other. Thus, when the irradiation of the infrared light from the first projector 11 and the irradiation of the infrared light from the second projector 21 are simultaneously performed, the quality of images imaged by the first camera 12 and the second camera 22 may deteriorate (for example, halation, and formation of unnecessary shadows) in the region where the irradiation of the infrared light from the first projector 11 and the irradiation of the infrared light from the second projector 21 overlap each other. In particular, in the present embodiment, the first camera 12 and the second camera 22 are disposed so as to image the same passenger (driver), and deterioration of image quality may occur in a portion that is most necessary in the control of the vehicle 100.

Thus, in the present embodiment, in each piece of frame processing performed in each frame processing cycle T (in an imaging cycle), the imaging control unit 431 controls the camera modules 10 and 20 so that a first irradiation/exposure period, which is a period in which the irradiation of the infrared light by the first projector 11 and the exposure to the infrared light in the first camera 12 are performed, does not overlap a second irradiation/exposure period, which is a period in which the irradiation of the infrared light by the second projector 21 and the exposure to the infrared light in the second camera 22 are performed. That is, in each piece of the frame processing, the imaging control unit 431 does not simultaneously perform the irradiation of the infrared light by the first projector 11 and the exposure to the infrared light in the first camera 12, and the irradiation of the infrared light by the second projector 21 and the exposure to the infrared light in the second camera. Thus the irradiation of the infrared light from the first projector 11 and the irradiation of the infrared light from the second projector 21 do not overlap each other, and thus the deterioration of the image quality is suppressed.

In addition, in the present embodiment, the imaging control unit 431 stops the irradiation of the infrared light by the first projector 11 and the second projector 21 when the exposure to the visible light is performed in the first camera 12 and the second camera 22. Thus, in the present embodiment, the imaging control unit 431 does not perform exposure to the infrared light in the first camera 12 and the second camera 22 when the exposure to the visible light is performed in the first camera 12 and the second camera 22. Thus, in the present embodiment, the exposure to the visible light in both cameras 12 and 22 is performed during a period other than the first irradiation/exposure period and the second irradiation/exposure period. In this way, by performing the exposure to the visible light when the irradiation of the infrared light is not performed by the projectors 11 and 21, an influence (for example, increase in redness) on the exposure to the visible light by the infrared light emitted by the projectors 11 and 21 is suppressed.

In the present embodiment, in each piece of the frame processing, the imaging control unit 431 causes both the first camera 12 and the second camera 22 to simultaneously perform the exposure to the visible light. Thus, the exposure to the visible light is performed in the same period in both the first camera 12 and the second camera 22. Even when the exposure to the visible light is simultaneously performed in the two cameras 12 and 22, the exposures do not influence each other, and thus the image quality of the images for the visible light imaged by the cameras 12 and 22 is less likely to deteriorate. In addition, in one piece of the frame processing, the exposure to the visible light is simultaneously performed for both the first camera 12 and the second camera 22, and thus the frame processing cycle T can be shortened as compared with a case where the exposure is separately performed.

FIG. 4 is a time chart showing an irradiation timing of the infrared light by the first projector 11, exposure timings of the infrared light and the visible light in the first camera 12, an irradiation timing of the infrared light by the second projector 21, and exposure timings of the infrared light and the visible light in the second camera 22. As illustrated in FIG. 4, in the present embodiment, the frame processing is performed at every optional frame processing cycle T (for example, several tens [ms] to several hundreds [ms]), and thus imaging by the camera modules 10 and 20 is performed at every frame processing cycle T.

In the example illustrated in FIG. 4, at time t₁, which is a start timing of one piece of frame processing, the first camera module 10 and the second camera module 20 receive an exposure start signal for the visible light from the imaging control unit 431, and the exposure to the visible light in the first camera 12 and the second camera 22 is started. In the present embodiment, the imaging control unit 431 simultaneously transmits an exposure start signal of the visible light to the first camera 12 and an exposure start signal of the visible light to the second camera 22. Thus, the exposure to the visible light in the first camera 12 and the exposure to the visible light in the second camera 22 are simultaneously started.

The exposure to the visible light in the first camera 12 and the second camera 22 is performed over a predetermined exposure time (or an exposure time included in the exposure start signal). In the present embodiment, the exposure time of the visible light in the first camera 12 and the exposure time of the visible light in the second camera 22 are the same time. Thus, in the present embodiment, the exposure period of the visible light in the first camera 12 and the exposure period of the visible light in the second camera 22 are the same period.

At time t₂ when a first offset time ΔT1 has elapsed from the time t₁, which is the start timing of the frame processing, the first camera module 10 receives the irradiation start signal and the exposure start signal of the infrared light from the imaging control unit 431, and the irradiation of the infrared light by the first projector 11 and the exposure to the infrared light in the first camera 12 are started. The first offset time ΔT1 is set to a time longer than the time required for the exposure to the visible light in the first camera 12 and the second camera 22.

The irradiation of the infrared light by the first projector 11 is performed over a predetermined irradiation time (or an irradiation time included in the irradiation start signal). Similarly, the exposure to the infrared light in the first camera 12 is also performed over a predetermined exposure time (or an exposure time included in the exposure start signal). In the present embodiment, the imaging control unit 431 simultaneously transmits the irradiation start signal and the exposure start signal of the infrared light (or transmits the signals as one signal for instruction of the start of both). In the present embodiment, the irradiation time and the exposure time of the infrared light are the same time. Thus, in the present embodiment, the period in which the irradiation of the infrared light is performed by the first projector 11 and the period in which the exposure to the infrared light in the first camera 12 is performed are the same period, and these periods are collectively referred to as the first irradiation/exposure period hereinafter. The period in which the irradiation of the infrared light is performed by the first projector 11 and the period in which the exposure to the infrared light in the first camera 12 is performed need not be the same period.

In the example shown in FIG. 4, at time t₃ when a second offset time ΔT2 has elapsed from the time t₂, the second camera module 20 receives the irradiation start signal and the exposure start signal of the infrared light from the imaging control unit 431, and the irradiation of the infrared light in the second projector 21 and the exposure to the infrared light in the second camera 22 are started. The second offset time ΔT2 is set to a period longer than the first irradiation/exposure period.

The irradiation of the infrared light by the second projector 21 is performed for a predetermined irradiation time (or an irradiation time included in the irradiation start signal). Similarly, the exposure to the infrared light in the second camera 22 is also performed over a predetermined exposure time (or an exposure time included in the exposure start signal). In the present embodiment, the imaging control unit 431 simultaneously transmits the irradiation start signal and the exposure start signal of the infrared light (or transmits the signals as one signal for instruction of the start of both). In the present embodiment, the irradiation time and the exposure time of the infrared light are the same time. Thus, in the present embodiment, the period in which the irradiation of the infrared light is performed by the second projector 21 and the period in which the exposure to the infrared light in the second camera 22 is performed are the same period, and these periods are collectively referred to as the second irradiation/exposure period hereinafter. The period in which the irradiation of the infrared light is performed by the second projector 21 and the period in which the exposure to the infrared light in the second camera 22 is performed need not be the same period. In the present embodiment, the irradiation time of the infrared light by the second projector 21 and the exposure time of the infrared light in the second camera 22 are the same time as the irradiation time of the infrared light by the first projector 11 and the exposure time of the infrared light in the first camera 12, respectively.

In the present embodiment, a time from the time t₃ to the time t₄ is also equal to the second offset time ΔT2. In the present embodiment, the second irradiation/exposure period is shorter than the second offset time ΔT2.

In the example shown in FIG. 4, the frame processing as described above is repeated for each frame processing cycle T. Thus, the exposure to the visible light in the first camera 12 and the second camera 22 is started at times t₄ and t₇ (start timing of pieces of the frame processing) when the frame processing cycle T has repeatedly elapsed from the time t₁. The first irradiation/exposure period is started at time t₅ when the first offset time ΔT1 has elapsed from the start timing of each piece of the frame processing. In addition, the second irradiation/exposure period is started at time t₆ when the first offset time ΔT1 and the second offset time ΔT2 have elapsed from the start timing of each piece of the frame processing.

In the above embodiment, both the first camera 12 and the second camera 22 have sensitivity to the visible light. However, only one of the first camera 12 and the second camera 22 may have the sensitivity to the visible light. In this case, only the camera having the sensitivity to the visible light (for example, only the first camera 12) performs imaging for the visible light. In this case, when one of the first camera 12 and the second camera 22 is performing the exposure to the visible light, the irradiation of the infrared light by the first projector 11 and the second projector 21 stops.

In addition, in a case where the imaging device 1 includes three or more camera modules, the imaging control unit 431 controls these camera modules such that the irradiation/exposure period of the infrared light of each camera module does not overlap the irradiation/exposure period of the infrared light of the other camera modules. In addition, when the camera of any camera module is performing the exposure to the visible light, the imaging control unit 431 stops the irradiation of the infrared light by the projector of the camera module.

### Second Embodiment

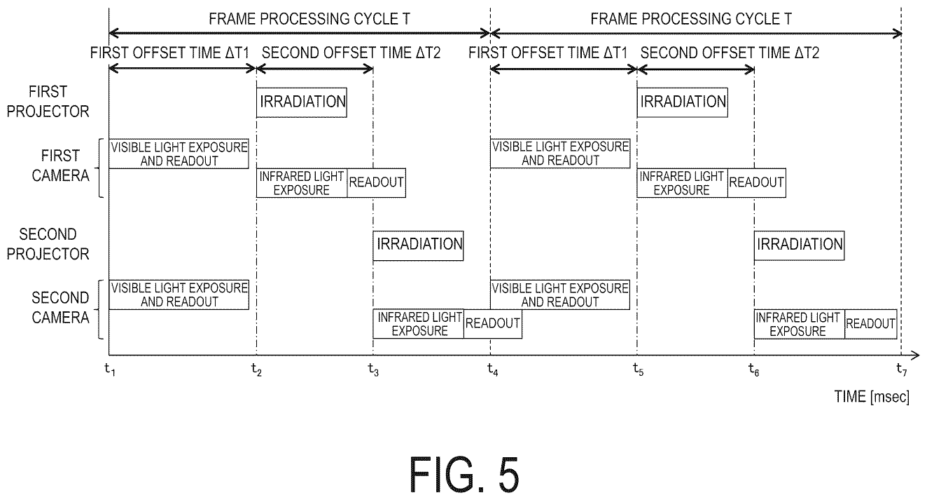

Next, the imaging device 1 according to a second embodiment will be described with reference to FIG. 5. The configuration and control of the imaging device 1 according to the second embodiment are basically the same as the configuration and control of the imaging device 1 according to the first embodiment. Hereinafter, portions different from the configuration and control of the imaging device 1 according to the first embodiment will be mainly described.

As described above, in the first camera 12 and the second camera 22, after the exposure to the infrared light and the exposure to the visible light, the readout for the infrared light and the readout for the visible light are performed, respectively. In the first embodiment described above, such readout is not taken into consideration. Thus, in the second embodiment, the imaging control unit 431 controls the camera modules 10 and 20 by taking into consideration such readout.

In the present embodiment, similarly to the first embodiment, in each piece of the frame processing (that is, in each imaging cycle), the imaging control unit 431 performs the irradiation of infrared light by the first projector 11 and the exposure to infrared light in the first camera 12 after the exposure to the visible light in the first camera 12 and the second camera 22 and before the irradiation of the infrared light by the second projector 21 and the exposure to the infrared light in the second camera 22 are performed.

In the present embodiment, in each piece of the frame processing, the imaging control unit 431 starts the irradiation of the infrared light by the second projector 21 and the exposure to the infrared light in the second camera 22 after completion of the irradiation of the infrared light by the first projector 11 and the exposure to the infrared light in the first camera and before completion of the readout for the infrared light from the first camera 12. That is, in each piece of the frame processing, the imaging control unit 431 starts the second irradiation/exposure period after completion of the first irradiation/exposure period and before completion of the readout in the first camera 12. Thus, when the irradiation of the infrared light by the first projector 11 and the exposure to the infrared light in the first camera 12 are completed, the irradiation of the infrared light by the second projector 21 and the exposure to the infrared light in the second camera 22 are started without waiting for the completion of the readout. As a result, lengthening of the frame processing cycle T is suppressed while making the exposure time of the infrared light in the first camera 12 as long as possible.

Furthermore, in the present embodiment, the imaging control unit 431 starts the exposure to the visible light in the first camera 12 and the second camera 22 after completion of the irradiation of the infrared light by the second projector 21 and the exposure to the infrared light in the second camera 22 and before completion of the readout for the infrared light in the second camera 22 corresponding to the exposure. That is, in each piece of the frame processing, the imaging control unit 431 starts the exposure to the visible light in both cameras 12 and 22 after completion of the second irradiation/exposure period and before completion of the readout for the infrared light in the second camera 22. Thus, when the irradiation of the infrared light by the second projector 21 and the exposure to the infrared light in the second camera 22 are completed, the exposure to the visible light is started in both cameras 12 and 22 without waiting for the completion of the readout. As a result, lengthening of the frame processing cycle T is suppressed while making the exposure time of the infrared light in the second camera 22 as long as possible.

In addition, in the present embodiment, in each piece of the frame processing, the imaging control unit 431 starts the irradiation of the infrared light by the first projector 11 and the exposure to the infrared light in the first camera 12 after the exposure to the visible light in the first camera 12 and the second camera 22 and the readout for the visible light of the first camera 12 and the second camera 22 corresponding to the exposure are completed. That is, the imaging control unit 431 starts the first irradiation/exposure period after the exposure to the visible light and the readout are completed in both cameras 12 and 22. Thus, the readout of the visible light including the light of a plurality of the colors of RGB and the exposure to the infrared light performed thereafter are not simultaneously performed in the first camera 12, and an increase in a processing load in the first camera 12 is suppressed.

FIG. 5 is a time chart similar to FIG. 4, showing the irradiation timing and the like of the infrared light by the first projector 11 when control according to a second embodiment is performed. As illustrated in FIG. 5, also in the present embodiment, the frame processing is performed at every optional frame processing cycle T (for example, several tens [ms] to several hundreds [ms]), and thus imaging by the camera modules 10 and 20 is performed at every frame processing cycle T.

Also in the example shown in FIG. 5, similarly to the example shown in FIG. 4, at the time t₁, the exposure to the visible light in the first camera 12 and the exposure to the visible light in the second camera 22 are simultaneously started. Then, in the first camera 12 and the second camera 22, the readout is sequentially performed for each column of the photoelectric conversion elements for which the exposure is completed. As shown in FIG. 5, the exposure to the visible light and the readout in the first camera 12 are almost simultaneously completed as the exposure to the visible light and the readout in the second camera 22.

At the time t₂ when the first offset time ΔT1 has elapsed from the time t₁, which is the start timing of the frame processing, the irradiation of the infrared light by the first projector 11 and the exposure in the first camera 12 are started, similarly to at the time t₂ in FIG. 4. The first offset time ΔT1 is set to a time as short as possible, while the time is longer than a time required for the exposure to the visible light and the readout in the first camera 12 and the second camera 22. As a result, the irradiation of the infrared light by the first projector 11 and the exposure in the first camera 12 are started after the readout for the visible light in the first camera 12 and the second camera 22 is completed.

In addition, in the first camera 12, when the exposure time of the infrared light is completed, the readout is performed immediately thereafter. In the present embodiment, since imaging with the infrared light is performed by the global shutter method in the first camera 12, the readout is sequentially performed from the capacitors corresponding to all the photoelectric conversion elements after the exposure is completed in all the photoelectric conversion elements (all the pixels) of the first camera 12.

In the example shown in FIG. 5, at time t₃ when the second offset time ΔT2 has elapsed from the time t₂, the irradiation of the infrared light by the second projector 21 and the exposure in the second camera 22 are started, similarly to the time t₃ in FIG. 4. The second offset time ΔT2 is set to be longer than the first irradiation/exposure period and shorter than a time obtained by adding a time until the readout for the infrared light is completed to the first irradiation/exposure period. As a result, the irradiation of the infrared light by the second projector 21 and the exposure in the second camera 22 are started during the readout period for the infrared light in the first camera 12.

In the present embodiment, a time from the time t₃ to the time t₄ is also equal to the second offset time ΔT2. The second offset time ΔT2 is set to be longer than the second irradiation/exposure period and shorter than a time obtained by adding a time until the readout for the infrared light is completed to the second irradiation/exposure period. As a result, the exposure to the visible light in the first camera 12 and the second camera 22 of the next frame processing is started during the readout period for the infrared light in the second camera 22.

In the example shown in FIG. 5, the irradiation of the infrared light by the second projector 21 and the exposure to the infrared light in the second camera 22 are always started during the readout period for the infrared light in the first camera 12. In addition, the exposure to the visible light in the first camera 12 and the second camera 22 is started during the readout period for the infrared light in the second camera 22. However, in a case where the exposure time is changed according to the brightness around the first camera 12 and the second camera 22, when the exposure time is short, the irradiation of the infrared light by the second projector 21 and the exposure in the second camera 22 may be started after the completion of the readout period for the infrared light in the first camera 12. Similarly, the exposure to the visible light in the first camera 12 and the second camera 22 may be started after the completion of the readout period for the infrared light in the second camera 22.

In the above-described embodiment, in the first camera 12 and the second camera 22, the readout from the corresponding capacitor is performed in different systems in the photoelectric conversion element provided with the filter that transmits the infrared light and in the photoelectric conversion element provided with the filter that transmits the visible light. However, the readout may be performed in the same system. In this case, the first camera 12 and the second camera 22 cannot perform the readout for the infrared light while performing the exposure to the visible light, and cannot perform the readout for the visible light while performing the exposure to the infrared light. Thus, in this case, the exposure to the visible light in the first camera 12 and the second camera 22 is started after the readout in the second camera 22 is completed.

Although the preferred embodiments according to the present disclosure have been described above, the present disclosure is not limited to these embodiments, and various modifications and changes can be made within the scope of the claims.

1. An imaging device configured to perform imaging, comprising:
a first camera and a second camera each having sensitivity to invisible light;
a first irradiation unit configured to irradiate an imaging range of the first camera with the invisible light during an exposure period of the invisible light in the first camera;
a second irradiation unit configured to irradiate an imaging range of the second camera with the invisible light during an exposure period of the invisible light in the second camera; and
a processor configured to control the first camera, the second camera, the first irradiation unit, and the second irradiation unit, wherein
an irradiation range of the invisible light by the first irradiation unit at least partially overlaps an irradiation range of the invisible light by the second irradiation unit,
at least one of the first camera and the second camera has sensitivity also to visible light, and
the processor is configured to stop invisible light irradiation by the first irradiation unit and the second irradiation unit when exposure to the visible light is performed in the at least one of the first camera and the second camera.

2. The imaging device according to claim 1, wherein
the first camera and the second camera both have sensitivity to the visible light, and
the processor is configured to cause both the first camera and the second camera to simultaneously perform exposure to the visible light.

3. The imaging device according to claim 1, wherein
in each imaging cycle, the processor is configured not to simultaneously perform irradiation by the first irradiation unit and exposure to the invisible light in the first camera, and irradiation by the second irradiation unit and exposure to the invisible light in the second camera.

4. The imaging device according to claim 3, wherein
in each imaging cycle, the processor is configured to perform the irradiation by the first irradiation unit and the exposure to the invisible light in the first camera after the exposure to the visible light in the first camera or the second camera and before the irradiation by the second irradiation unit and the exposure to the invisible light in the second camera are performed, and
the processor is configured to start the irradiation by the second irradiation unit and the exposure to the invisible light in the second camera after completion of the irradiation by the first irradiation unit and the exposure to the invisible light in the first camera and before completion of the readout for the invisible light from the first camera.

5. The imaging device according to claim 4, wherein
in each imaging cycle, the processor is configured to start the exposure to the visible light in the at least one of the first camera and the second camera after completion of the irradiation by the second irradiation unit and the exposure to the invisible light in the second camera and before completion of the readout from the second camera corresponding to the exposure.

6. The imaging device according to claim 3, wherein
in each imaging cycle, the processor is configured to start the irradiation by the first irradiation unit and the exposure to the invisible light in the first camera after the exposure to the visible light and the readout corresponding to the exposure are completed in the at least one of the first camera and the second camera.

7. The imaging device according to claim 1, wherein
the processor is configured to perform exposure to the invisible light and readout corresponding to the exposure in the first camera and the second camera in a global shutter system, and performs the exposure to the visible light and readout corresponding to the exposure in the first camera and the second camera in a rolling shutter system.

8. The imaging device according to claim 1, wherein
the invisible light is infrared light.

9. The imaging device according to claim 1, wherein
the imaging device is equipped on one vehicle.

10. The imaging device according to claim 9, wherein
the first camera and the second camera are disposed to image the same passenger of the vehicle.

11. An imaging control method, the method controlling
a first camera and a second camera each having sensitivity to visible light and invisible light,
a first irradiation unit configured to irradiate an imaging range of the first camera with the invisible light during an exposure period of the invisible light in the first camera, and
a second irradiation unit configured to irradiate an imaging range of the second camera with the invisible light during an exposure period of the invisible light in the second camera, wherein
an irradiation range of the invisible light by the first irradiation unit at least partially overlaps an irradiation range of the invisible light by the second irradiation unit, and
the imaging control method comprises stopping invisible light irradiation by the first irradiation unit and the second irradiation unit when exposure to the visible light is performed in at least one of the first camera and the second camera.

12. A non-transitory computer medium having recorded thereon an imaging control program, the imaging control program being configured to control:
a first camera and a second camera each having sensitivity to visible light and invisible light;
a first irradiation unit configured to irradiate an imaging range of the first camera with the invisible light during an exposure period of the invisible light in the first camera; and
a second irradiation unit configured to irradiate an imaging range of the second camera with the invisible light during an exposure period of the invisible light in the second camera, wherein
an irradiation range of the invisible light by the first irradiation unit at least partially overlaps an irradiation range of the invisible light by the second irradiation unit, and
the imaging control program causes a computer to execute stopping of invisible light irradiation by the first irradiation unit and the second irradiation unit when exposure to the visible light is performed in at least one of the first camera and the second camera.
